(19) United States
(12) Patent Application Publication
(10) Pub. No.: US 2006/0218485 A1
(43) Pub. Date: Sep. 28, 2006

(54) Process for automatic data annotation, selection, and utilization

(76) Inventor: Daniel Blumenthal, Newton, MA (US)

Correspondence Address: JOHN ALEXANDER GALBREATH, 2516 CHESTNUT WOODS CT, REISTERSTOWN, MD, 21136, US

(21) Appl. No.: 11/376,361

(22) Filed: Mar. 15, 2006

Related U.S. Application Data
(60) Provisional application No. 60/665,527, filed on Mar. 25, 2005.

(51) Int. Cl. G06F 17/00

(52) U.S. Cl. 715/512

(57) ABSTRACT

Systems and methods for the automatic annotation of data are disclosed, particularly a process and system for enabling users to generate automatic annotations, to select one or more of those annotations, and to utilize the selected annotations and their various relationships to the annotated data.

### CROSS-REFERENCES TO RELATED APPLICATIONS

This application claims priority from, and the benefit of, applicant's provisional U.S. Patent Application No. 60/665,527, filed Mar. 25, 2005 and titled “Process for Automatic Data Annotation, Selection, and Utilization”. The disclosures of said application and its entire file wrapper (including all prior art references cited therein) are hereby specifically incorporated herein by reference in their entirety as if set forth fully herein. Furthermore, a portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Invention

The disclosed systems and methods relate generally to the automatic annotation of data, particularly to a method for enabling users to generate automatic annotations, to select one or more of those annotations, and to utilize the selected annotations and their various relationships to the annotated data.

2. Description of the Related Art

The process of merely annotating Internet websites is known in the prior art; for examples, see the websites www.rikai.com and www.popjisyo.com. However, these websites do not allow the user to select, collect, and/or collate the annotations that are made, as in the process of the present invention. Instead, the annotations in these prior art websites are purely for reference—these websites do not allow the user to do anything with the annotations.

This is an important difference between the prior art and the present invention, because the real power and value of the invention comes not from merely annotating in the conventional sense. Rather, the invention provides for distinctive types of annotation, and then allows the user to select and utilize the annotation to increase his learning or perform a task.

### SUMMARY OF THE INVENTION

The invention is a process that automatically annotates arbitrary collections of data, and then allows users to cull from the annotated data those words, phrases, sentence constructions, numbers, references, etc., which they wish to examine more closely. The process thus provides a mechanism by which users may study, learn, or otherwise utilize the specific materials they have selected from the annotated data.

A broad object of the invention is to allow users to utilize the information imparted by an annotation to perform a task—i.e., not just annotating for reference.

A more specific object of the invention is to allow users to increase their knowledge of annotated terms in a foreign-language data collection such as a webpage, newspaper, etc., by providing translations when an annotated term is selected.

A further object of the invention is to allow users to test their knowledge of the annotated terms, by allowing users to add selected annotated terms to a vocabulary list, and subsequently test their knowledge of that list (annotated terms and associated translations) by taking a vocabulary test.

A further object of the invention is to provide a process and system that can be used to annotate many different forms of data, including but not limited to webpages, text, speech, spreadsheets, musical recordings, computer files, etc.

A further object of the invention is to provide a process and system that can annotate data in many different ways, including but not limited to highlighting, graphics, audio or video indications, highlighting, etc.

A further object of the invention is to provide a process and system that can provide information to a user in a variety of ways when the user selects an annotation, including but not limited to visual, tactile, auditory, olfactory, and taste-related feedback.

Further objects and advantages of the invention will become apparent from a consideration of the ensuing description and drawings.

### DESCRIPTION OF THE DRAWINGS

FIG. 1 is a flow diagram that illustrates the basic steps and principles in the process of the invention.

FIG. 2 shows an entry screen for specifying a website to be annotated.

FIG. 3 shows a screen with one frame containing a list of selected items, and another frame which contains the annotated text of the website.

FIG. 4 shows a pop-up box with annotations relating to the highlighted text.

FIG. 5 shows a quiz screen.

FIG. 6 shows a notification of an incorrect answer on the quiz screen.

### DETAILED DESCRIPTION OF THE INVENTION

The following provides a list of the reference characters used in the drawings:
10. Data collection
11. Analysis and annotation step
12. Database
13. Presentation step
14. Selection step
15. Utilization step
16. URL address
17. Translate-from drop-down menu
18. Annotation
19. Pop-up box
20. Gender
21. Translation
22. List of selected items
23. Quiz
24. Foreign language word
25. Space
26. Correct answer
27. Translate-to drop-down menu
28. “Add this word to the test” button
29. “Start the test” button
30. “Analyze” button

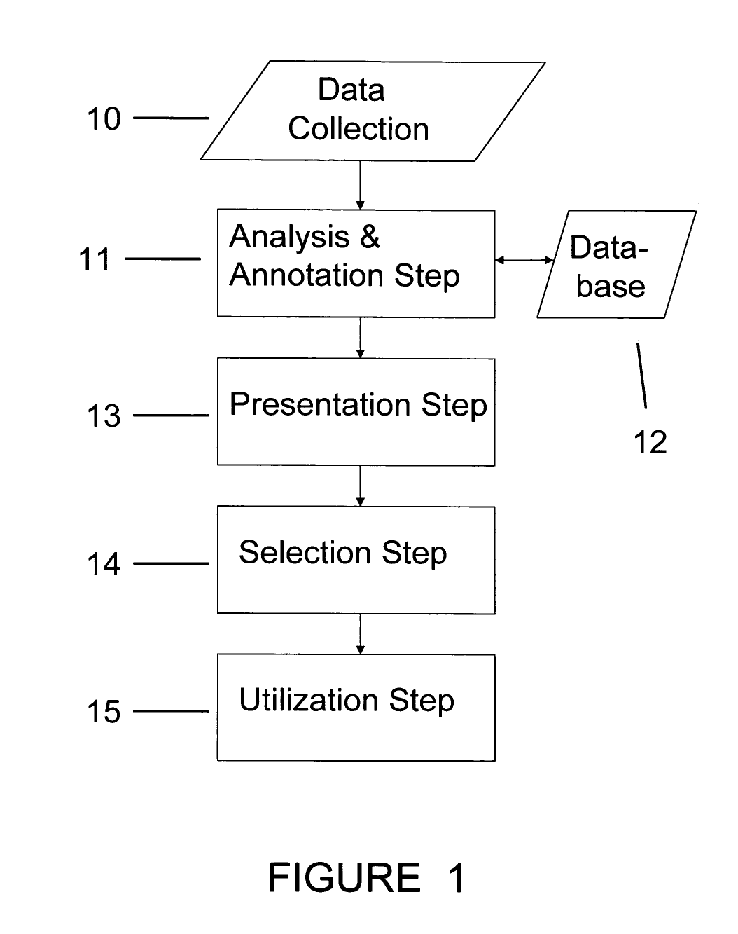

FIG. 1 diagrammatically illustrates the basic steps and principles in the process. A user, autonomous or semi-autonomous agent, or automated process specifies a data collection 10 to be annotated. Data collection 10 could comprise a web page, text directly input for annotation, speech, mathematical formulas, a spreadsheet, lists or graphs of numbers, musical recordings, sheet music, speech, one or more computer files or print documents, databases, data culled from medical equipment, data specified by another method, or any combination of these. Data collection 10 could be complete at the time of specification, or it could be a continuous or discontinuous stream of data being received in real-time (e.g., a simultaneous interpreter could configure a software implementation to annotate a speech as it is being made).

Data collection 10 first undergoes a data analysis and annotation step 11. In analysis and annotation step 11, pieces of data collection 10 are compared against information in database 12, said database 12 being internal or otherwise accessible to the process. When a connection, association, or correlation is found between a particular piece of data collection 10 and information in database 12, that piece of data is annotated to reference the information.

The following describes an example of one way in which analysis and annotation step 11 could be performed. A user, interacting with a web site, would specify the URL of an English-language website to be annotated in Spanish. This URL would be communicated to a web server running a Java serviet, which would read the website specified by the URL. Having read the site into memory, the servlet would then interface with a database (also on the server), and analyze the website in the following way: first, it would look for logical breaks in the data based on punctuation, line breaks, and formatting data. For each of the resulting pieces of data, it would search for matching or correlating entries in its internal or otherwise accessible database.

For example, let's say the phrase “The quick brown fox jumps over the lazy dog” is a piece of data identified in the data collection to be annotated. The servlet would first search its database of words and phrases for “the quick brown fox”. Note that the servlet could search for more or less than four words at a time (out of the total nine words in the phrase), based on user preference, processor speed, or other reasons. Likewise, analysis could be based on sentence structure, context, formatting, contiguous or non-contiguous text, or other factors. If “the quick brown fox” wasn't found, the servlet would then search for “the quick brown”. If that also wasn't found, the servlet would search for “the quick”. If this were found then it would annotate “the quick” with the corresponding text in the desired language—say, Spanish.

Then, “the quick” having been found and annotated, the servlet would start over with the remaining seven words in the original nine word phrase—that is, “brown fox jumps over the lazy dog”. Again taking a four-word “chunk”, the servlet would first search for “brown fox jumps over”, then “brown fox jumps”, then “brown fox”, then “brown”. If none of these were found, then it would leave “brown” alone (i.e., not annotate it), and continue on with “fox jumps over the lazy dog”. Note that this is only one example of an algorithm controlling how the collection of data is compared to internal databases during the annotation step. Certainly, other algorithms could be used, such as one that takes each individual word in the collection of data and compares it to words in the internal database.

When analysis and annotation step 11 is complete, and no further connections, associations, or correlations can be found between data collection 10 and information in database 12, the Java servlet returns the annotated data to the user, including any appropriate HTML markup, in presentation step 13. The process can visually display the annotated data collection to the user, or present the annotations in some other suitable way.

The user then selects an annotation or annotations in selection step 14, e.g., by moving the cursor over the annotation to see relevant information or see possible options for taking an action like adding the annotation to a list. In utilization step 15, the user then takes an action based on the information or possible options revealed in selection step 14. The user thus uses the annotations—for example, by adding annotation 18 to a list. The user can subsequently take additional actions related to the annotations, like taking a vocabulary test of the annotated words that were added to the list.

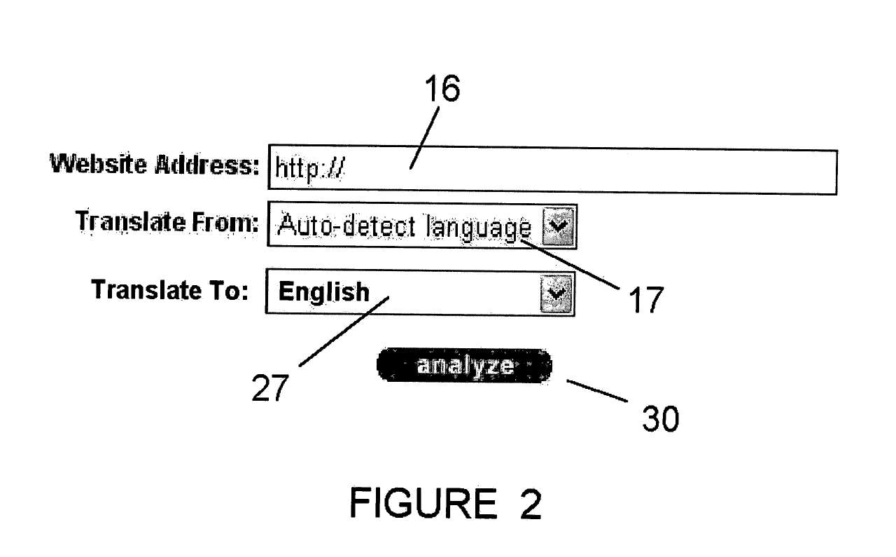

FIG. 2 shows an example of specifying a data collection 10, wherein an entry screen allows a user or agent to specify the URL address 16 for a webpage to be annotated, and to optionally specify the language of the webpage via a translate-from drop-down menu 17. Using translate-from drop-down menu 17, a user could specify that the webpage was in Spanish, French, or some other language, or alternatively could specify that the process automatically detect the language of the webpage. The user can also specify the language in which the annotations will be presented, via translate-to drop-down menu 27. After the user has entered the above inputs, he clicks on “Analyze” button 30 to start analysis and annotation step 11.

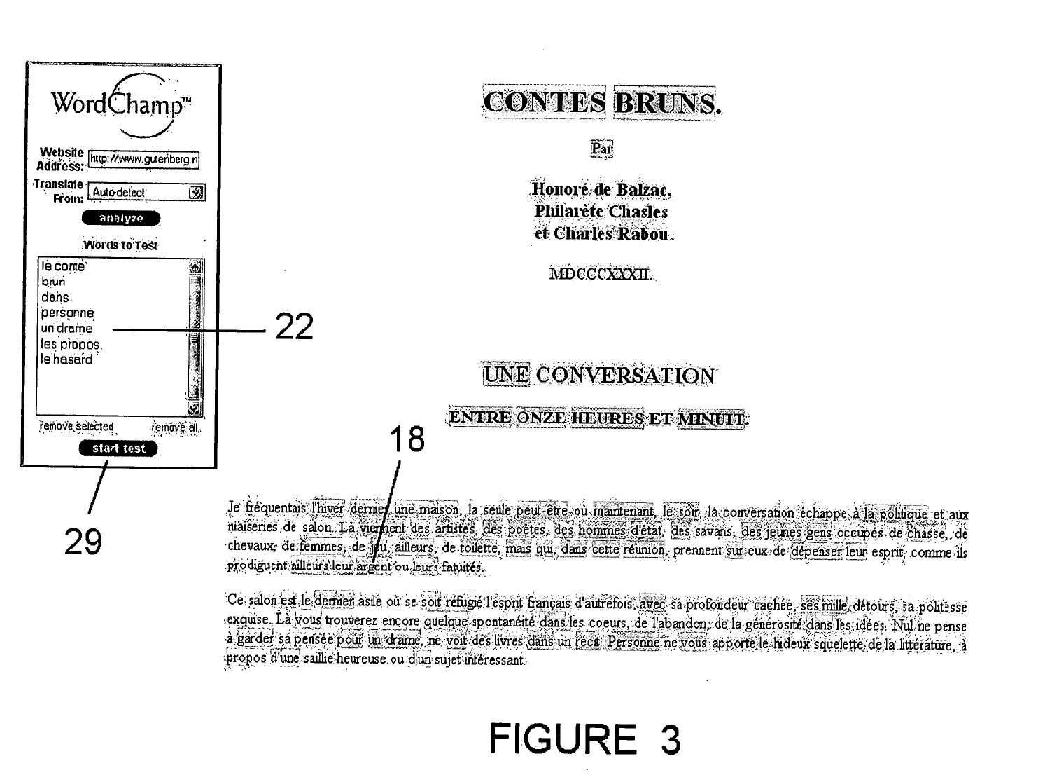

FIG. 3 shows an example of a webpage which has undergone analysis and annotation step 11, and has been displayed to the user in presentation step 13. In this example, the annotations are indicated by highlighted text, including a particular annotation 18 relating to the French word “argent”.

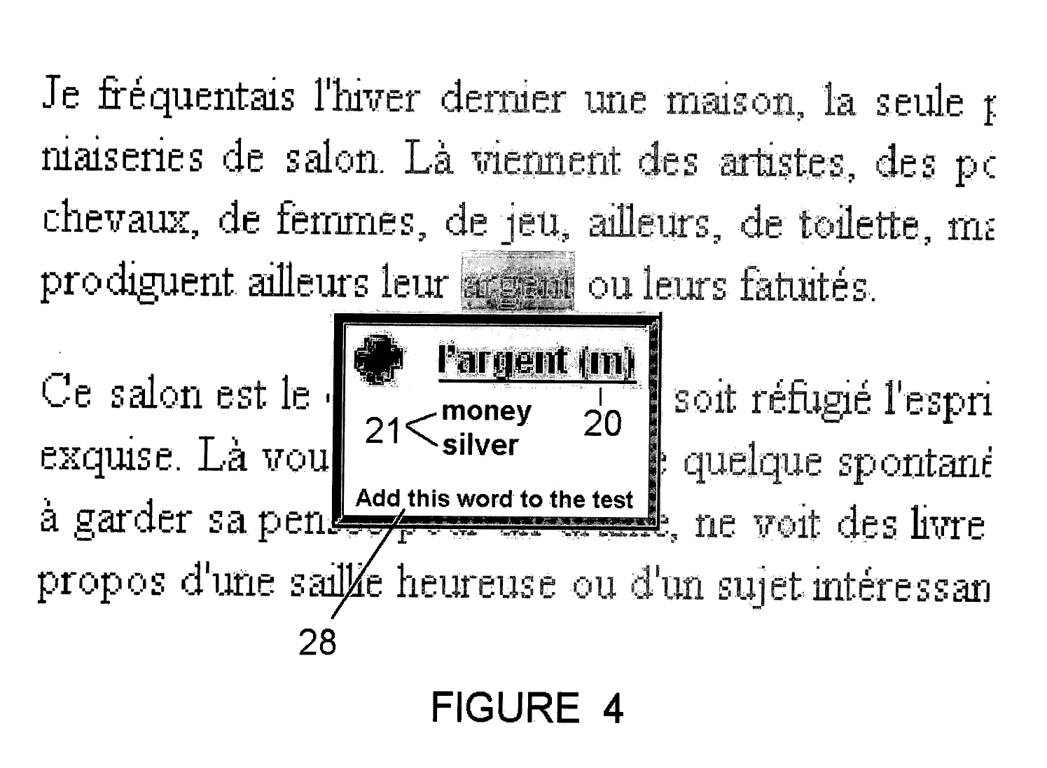

In selection step 14, the user moves the cursor over the annotated text, and a pop-up box containing information related to annotation 18 appears. FIG. 4 shows such a pop-up box 19, with information including the French word's gender 20 and English translation 21. An “Add this word to the test” button 28 appears along with the other information in pop-up box 19. A user could alternatively select an annotation by clicking on a hyperlink, voice command, eye tracking device, joystick, electroencephalograph, or other method. A user could select one or more annotations, all annotations simultaneously, or set up an automated process to select a particular type of annotation (e.g., references to case law, intransitive verbs, etc.).

FIG. 3 also shows an example of utilization step 14. In this example, when the user selects the annotation by moving the cursor over a piece of annotated text, the user can then choose to take an action related to the annotation—for example, the user can choose to click on “Add this word to the test” button 28 and add the annotated text to the list of selected items 22. It can be appreciated that other actions can be taken by the user based on the information provided by annotation 18, and examples of such other actions are described later in this disclosure.

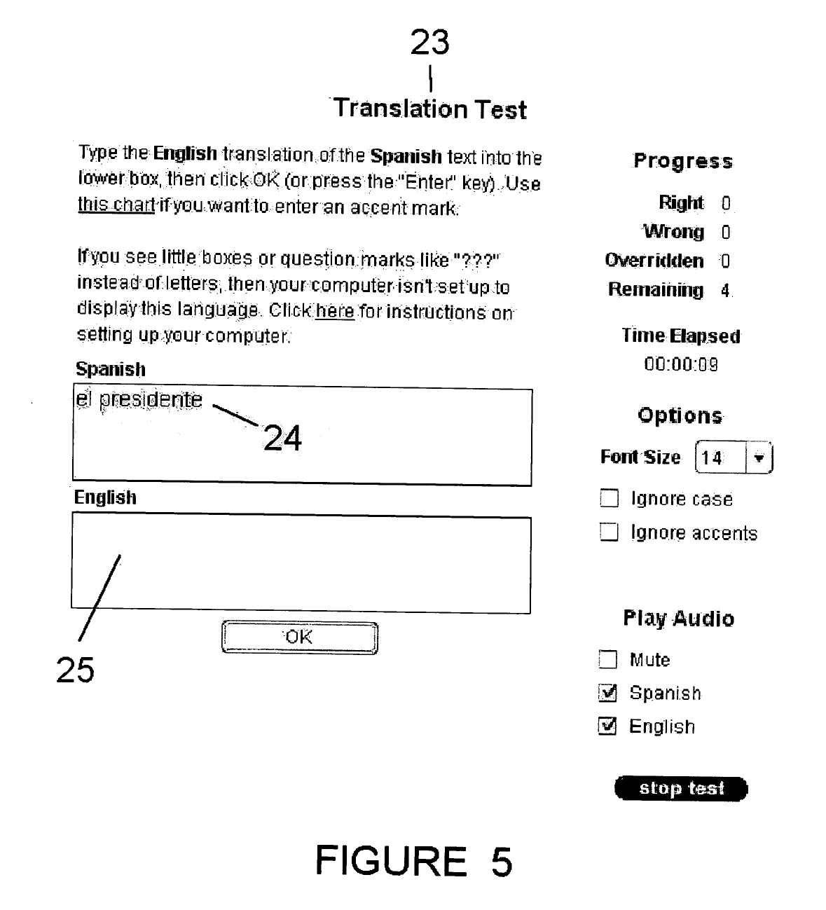

The user can also take additional actions related to the annotations, and FIG. 5 shows one such example. A quiz 23 is automatically generated from a list of selected items, such as the list of selected items 22 shown in FIG. 3. (Note, however, that the FIG. 5 quiz tests knowledge of Spanish words, whereas in FIG. 3 the selected words are French.) The user clicks on a “Start test” button 29, and is presented with a foreign language word 24 (here, “el presidente”), and required to correctly enter the translation in the provided space 25. If the user enters the correct response, foreign language word 24 is removed from the list and quiz 23 moves to the next question.

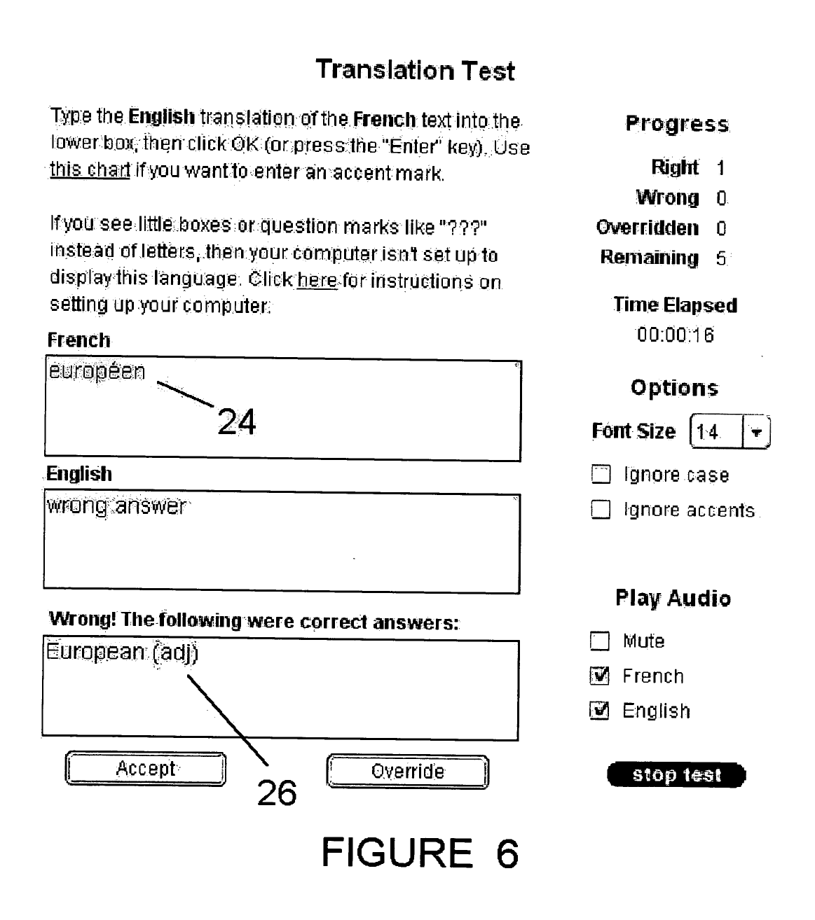

If an incorrect answer is entered, then, as shown in FIG. 6, the user is provided with the correct answer 26 before quiz 23 continues. (Note that FIG. 6 provides a correct English translation of the French word “européen”, rather than the Spanish word “el presidente”.) Quiz 23 could return an incorrectly answered question to the list, either at a predetermined or random location. Alternatively, it could add an incorrectly-answered question back into the list at multiple locations, in order to force the user to answer correctly multiple times. The determination of location could be random, or at specific intervals to correspond to the points at which short-term memory is exhausted, in order to make sure the correct answer is entering long-term memory. It could be presented to the user after a particular amount of time has elapsed, or, more simply, added back into the list of remaining questions at a pre-determined location, and at the end of the list.

### RAMIFICATIONS AND SCOPE

While the above description contains many specificities, these shall not be construed as limitations on the scope of the invention, but rather as exemplifications of embodiments thereof. Many other variations are possible without departing from the spirit of the invention. Examples of just a few of the possible variations follow:

A user could optionally specify additional attributes relating to the data, or preferences about the way in which the data is to be annotated. These additional attributes and preferences control the resources used for the annotation step in the process (i.e., the databases that the collection of data is compared against), and the output of the annotation step (i.e., what is presented when the user clicks on or otherwise accesses an annotation. It can be appreciated that a user can either enter the additional attributes and preferences each time each time he goes through the process, or the additional attributes can be supplied from previous inputs that have become part of a previously-created user profile. For instance, the user could specify the source language of the data, or the desired language or format of the annotations. The user could specify that the program should be aware of special terminology, or reference texts. For instance, a lawyer wishing to annotate a legal brief could specify that a legal dictionary be included in the databases searched in order to better annotate legal jargon contained in the legal brief; or request that references to case law in the legal brief (e.g., Brown v. Board of Education) be annotated with links to reference material about the particular case or other appropriate reference material; or request that the annotations be made in French. Likewise, a medical student could specify an entirely different set of preferences to annotate a medical journal article—e.g., that medically-oriented databases be consulted for the annotation step, or that the resulting annotations display specific, medically-useful characteristics when accessed by the user. The user could specify that images or video, tactile feedback (e.g., in the form of a rumble pack), audio, olfactory, taste-related, or other feedback be included when the annotations are presented to, or selected by, the user.

In analysis and annotation step 11, the process could look for individual words or groups of words, sentence constructions, idioms, jargon, a particular verb conjugation or grammatical construct, or references to external material (e.g., case law, medical experiments, publications, etc.) or people. Upon finding a localized instance of data to be annotated in accordance with the preferences (either specified or default), an annotation would be added to the data.

The presence of an annotation could be indicated by a superscript, a subscript, format change (possibly but not necessarily including italics, bold text, typeface or size changes, highlighting, etc.), a graphic, audio indication, mark-up, or other method. Alternatively, it might not be overtly indicated. The annotation itself could take the form of a footnote, an endnote, a sidebar, inline text delimited by parentheses or brackets, sound file, image, hyperlink, executable code, or commands recognized by an industrial robot, pacemaker, or automated drug delivery system.

Annotations could be in the form of translations for foreign words, definitions for words in the same language, grammatical notes, examples of usage, images, photographs, references to supplemental information, text explanations, hyperlinks, audio clips, musical scores, video, scents, tactile feedback, executable programs, commands for open or proprietary systems, other forms, or a combination of any of the above.

Depending on the type of annotation, users could use the annotations in a variety of ways, in addition to the embodiment described above (wherein a user selects unfamiliar vocabulary from a foreign language publication, then learns the vocabulary interactively in an automatically generated quiz). For instance, a user curious about an obscure court case mentioned in a news article could choose to follow a hyperlink added as an annotation to the original text, and review supplementary material provided elsewhere. Or, the writer of a journal article could automatically generate a bibliography, selecting only appropriate items. The invention also has application in the medical field: medical data would flow from instruments such as heart rate monitors, blood pressure monitors, electroencephalographs, etc. into a patient's “electronic chart”. The process would annotate this medical data by comparing it against internal or external databases. The doctor could select an annotation from the chart—say, an annotation that specifies a particular drug and dosage to address a high blood pressure condition which the process identified in the medical data—and then take an action like automatically adding the drug to a patient's IV.

A list of annotations or a corresponding automatically-generated methodology for use (e.g., a quiz or instructions to a pacemaker) could be saved, and used again later on the same or different media, in the same or in a different format. For instance, a quiz could be generated by selecting unknown words from an annotated foreign language website, then this quiz could be accessed later over a handheld device such as a mobile phone or PDA, or the same data could be utilized in a different manner at the same or a later time. Likewise, a user could be able to view the results of past usage, and modify the list of selections, or set up the process to automatically alter it based on performance. A teacher could be able to select difficult words from a source text and have his or her students practice those words using a variety of different drills.

In addition to the vocabulary quiz in the embodiment discussed above, the following are examples of different types of automatically generated quizzes which could be used in a context in which the annotations were used to learn information. The user could be asked multiple-choice questions, be required to fill in blanks with different conjugations, or provide the correct translation for a particular word or phrase. The user could be presented with the initial data and asked for the annotation (or the reverse), with or without audio or graphic clues. The quiz could utilize speech recognition technology to determine the accuracy of a spoken response, or require the user to diagram a sentence. The annotations could be organized into a crossword puzzle or word game. Graphical annotations could be organized into a game of solitaire, or three dimensional puzzle. A user could reproduce an audio clip through a MIDI connection, or identify a musical score from a few bars.

The system could be delivered as a web application installed on a server and publicly accessed over the Internet, or as a standalone software application, a plugin for another software product (e.g., browser, word processor, music composing software, etc.), a distributed application, a dedicated embedded device, an embedded application for a handheld device or cell phone, expert system, artificial intelligence, or through another method.

The data used to generate annotations could be stored in one or more databases, files, file systems, embedded ROM chips, or culled from sources over the Internet, local resources accessed over an intranet, experts consulted in real-time or asynchronously, other sources, or a combination of any of the above.

A doctor could use an implementation to automatically analyze a patient's medical record. Annotations could be in the form of recommendations for treatment, links to journal articles, contact information for the physician who had made a change in treatment, or commands which could automatically be sent to medical equipment (e.g., for the delivery of drugs). This information could be culled from medical studies, information provided by pharmaceutical companies, observations by other staff members, insurance information, medical databases, hospital databases, and possibly modified by the doctor's personal preferences for one treatment option over another. The doctor could select several annotations, and these annotations could be reviewed by other doctors or nurses, or acted upon by automated machinery.

An engineer could use an implementation to automatically analyze a piece of code. Annotations could be in the form of documentation, sample code, articles relating to programming topics, references to locations where a function is called, comments/markup by other programmers, or entries in a bug database indicating problems with the analyzed section. The engineer could select some of these annotations for the purposes of reference, preparation for a code review, or to review unfamiliar programming concepts, constructs, or API calls. The annotations could be used in the form of a tutorial, programming test, or the creation of an automated testing suite (e.g., annotations would indicate bugs or inefficiencies, the programmer would select one or more to work on, and upon completion automatically start an automated battery of test cases), or other method.

A human resources department could use an implementation to automatically analyze a resume. Annotations could be in the form of contact information for educational institutions, prior work environments, or references. Clicking on a button would automatically place a phone call or send an email to the specified contact. Skills desired by different areas of the organization could be highlighted, with contact information for the project leaders included. The human resources employee could then select certain annotations, and send them to managers who would review them and make decisions on whether or not to interview a candidate. The managers could then review these lists of information before interviewing a candidate.

A musician could use an implementation to automatically analyze a piece of sheet music, or a musical track. Annotations could be in the form of an audio clip (either synthesized or from a library of audio clips), or could display similarities between a section of music and other works. The musician could select annotations referring to areas of interest (or of particular difficulty) in the music, then practice using a custom interface and MIDI instrument.

A trainee's responses to a standardized training system could be automatically analyzed, with mistakes or areas for improvement annotated. The system would then allow the trainee (or a manager) to select specific areas on which to focus, and would then test the trainee specifically on those areas.

Accordingly, the scope of the invention should be determined not by the embodiments illustrated, but by the appended claims and their legal equivalents.

What is claimed is:

1. A process for data annotation, selection, and utilization, comprising the steps of:
(a) specifying a data collection to be annotated;
(b) analyzing at least one element of said data collection against a database and annotating said element when an association is found between said element and information in said database;
(c) presenting said data collection with said annotated element;
(d) selecting said annotated element, thereby accessing said information from said database;
(e) utilizing said information to perform a task.

2. The process of claim 1, wherein said data collection is an Internet page.

3. The process of claim 1, wherein said process further comprises the step of specifying the language of said data collection.

4. The process of claim 1, wherein said process further comprises the step of automatically detecting the language of said data collection.

5. The process of claim 1, wherein said process further comprises the step of specifying the language of said information supplied by said annotated element.

6. The process of claim 1, wherein said presenting step includes visually displaying said data collection with said annotated element.

7. The process of claim 1, wherein a plurality of elements of said data collection are annotated, and said selecting step includes selecting more than one of said annotated elements.

8. The process of claim 1, wherein said information from said database includes a translation of said element into another language.

9. The process of claim 1, wherein said utilizing step includes adding said element to a list.

10. The process of claim 9, wherein said list is a vocabulary list, and said utilizing step further comprises testing knowledge of said vocabulary list, including said element and said element's foreign language equivalent.

11. A system for annotating, selecting, and utilizing data, comprising:
(a) a processor having means for receiving a data collection to be annotated, and adapted to automatically compare at least one portion of said data collection against a database and annotate said portion when said processor finds an association between said portion and information in said database;
(b) means for communicating said data collection with said annotated portion to a user;
(c) means for selecting, by said user, said annotated portion, said user thereby accessing said information from said database;
(d) means for utilizing, by said user, said information to perform a task.

12. The process of claim 11, wherein said data collection is an Internet page.

13. The process of claim 11, wherein said system further comprises means for specifying the language of said data collection.

14. The process of claim 11, wherein said system further comprises means for automatically detecting the language of said data collection.

15. The process of claim 11, wherein said system further comprises means for specifying the language of said information supplied by said annotated portion.

16. The process of claim 11, wherein said means for communicating includes a display for visually communicating said data collection with said annotated portion.

17. The process of claim 11, wherein a plurality of portions of said data collection are annotated, and said user selects more than one of said annotated portions.

18. The process of claim 11, wherein said information from said database includes a translation of said portion into another language.

19. The process of claim 11, wherein said user utilizes said information by adding said annotated portion to a list.

20. The process of claim 19, wherein said list is a vocabulary list, and said user further utilizes said information by testing knowledge of said vocabulary list, including said annotated portion and said annotated portion's foreign language equivalent.
